(19) United States
(12) Patent Application Publication
(10) Pub. No.: US 2018/0163111 A1
(43) Pub. Date: Jun. 14, 2018

(54) THERMAL CONDUCTIVE PLASTIC MATERIAL AND METHOD OF MANUFACTURING THE SAME

(71) Applicant: National Chung-Shan Institute of Science and Technology, Taoyuan City (TW)

(72) Inventors: CHIEN-LIANG CHANG, Taoyuan City (TW); WU-CHING HUNG, Taoyuan City (TW); CHII-RONG YANG, Taoyuan City (TW); CHANG-DA CHEN, Taoyuan City (TW); CHIA CHENG, Taoyuan City (TW)

(21) Appl. No.: 15/378,769

(22) Filed: Dec. 14, 2016

(51) Int. Cl. C09K 5/14; B01J 19/08; C08K 3/04; C08K 3/28

(52) U.S. Cl. CPC C09K 5/14; B01J 19/081; C08K 3/04; C08K 2003/282; B01J 2219/0879; B01J 2219/0894; C08K 2201/001; C08K 3/28

(57) ABSTRACT

A thermal conductive plastic material, comprising: a plastic solution; a first thermal conductive material, filled and distributed in the plastic solution, being processed by an Atmospheric Pressure Plasma (APP) technology, and having its surface provided with hydrophilic functional groups; and a second thermal conductive material, filled and distributed in the plastic solution, being processed by the Atmospheric Pressure Plasma (APP) technology or chemical modification, and having its surface provided with hydrophilic functional groups. Wherein, the first thermal conductive material is formed by ceramic powders, the second thermal conductive material is formed by carbon-containing ingredient, while the first thermal conductive material and the second thermal conductive material are in touch with each other.

### BACKGROUND OF THE INVENTION

### Field of the Invention

The present invention relates to a thermal conductive plastic material and method of manufacturing the same, and in particular to a thermal conductive plastic material and method of manufacturing the same, realized through utilizing an Atmospheric Pressure Plasma (APP) technology.

### The Prior Arts

Nowadays, the electronic devices are designed to provide a variety of functions, and while in operation, they consume large amount of electrical energy and produce quite large amount of heat. Therefore, the problem of heat dissipation is crucial to their performance. Usually, thermal conductive plastic material is used as a medium to dissipate heat, and quite often, in the thermal conductive plastic material, a thermal conductive medium is added as a thermal interface material (TIM), to raise the overall thermal conduction coefficient of the thermal conductive plastic material, to enhance the heat dissipation effect. However, for the existing technology, the heat dissipation capability of the thermal conductive plastic material still has much to be desired.

Therefore, presently, the design and performance of the thermal conductive plastic material is not quite satisfactory, and it leaves much room for improvement.

### SUMMARY OF THE INVENTION

In view of the problems and drawbacks of the prior art, the present invention provides a thermal conductive plastic material having superior heat dissipation capability.

The present invention provides a thermal conductive plastic material, comprising: a plastic solution, a first thermal conductive material, and a second thermal conductive material. The first thermal conductive material is filled and distributed in the plastic material, being processed by the Atmospheric Pressure Plasma (APP) technology, and having its surface provided with hydrophilic functional groups. The second thermal conductive material is filled and distributed in the plastic material, being processed by the Atmospheric Pressure Plasma (APP) technology or chemical modification, and having its surface provided with hydrophilic functional groups. Wherein, the first thermal conductive material is formed by ceramic powders, the second thermal conductive material is formed by carbon-containing ingredient, while the first thermal conductive material and the second thermal conductive material are in touch with each other.

The present invention also provides a thermal conductive plastic material manufacturing method, comprising the following steps: preparing the first thermal conductive material and the second thermal conductive material, both being processed by the Atmospheric Pressure Plasma (APP) technology, thus having hydrophilic function groups on their surfaces; mixing the first thermal conductive material and the second thermal conductive material evenly into the plastic solution, to obtain a thermal conductive plastic material solution; utilizing a vacuum stirring and degassing device, to stir the first thermal conductive material and the second thermal conductive material, so that they are distributed evenly in the plastic solution, while discharging the bubbles from the plastic solution; and curing the thermal conductive plastic material solution into the thermal conductive plastic material.

The advantage of the present invention is that: through mixing in the plastic solution the first thermal conductive material and the second thermal conductive material serving as thermal interface material (TIM), heat can be fully dissipated through the thermal conduction path formed by the first thermal conductive material and the second thermal conductive material, to ensure efficient heat dissipation. Further, the first thermal conductive material and the second thermal conductive material have been performed surface modification treatment in advance through using the Atmospheric Pressure Plasma (APP) technology, to raise distribution rate of the first thermal conductive material and the second thermal conductive material in the plastic solution, thus further raising its heat dissipation capability.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detail descriptions.

### BRIEF DESCRIPTION OF THE DRAWINGS

The related drawings in connection with the detailed descriptions of the present invention to be made later are described briefly as follows, in which:

FIG. 1 is schematic diagram of a thermal conductive plastic material according to an embodiment of the present invention;

FIG. 2 is a flowchart of the steps of a thermal conductive plastic material manufacturing method according to an embodiment of the present invention; and

FIG. 3 is schematic diagram of equipment used to perform surface modification treatment for the first thermal conductive material and the second thermal conductive material through using the Atmospheric Pressure Plasma (APP) technology according to an embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

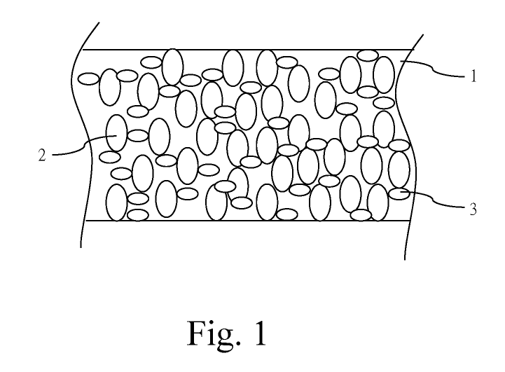

Refer to FIG. 1 for schematic diagram of a thermal conductive plastic material according to an embodiment of the present invention.

As shown in FIG. 1, the present invention provides a thermal conductive plastic material, comprising: a plastic solution 1; a first thermal conductive material 2, filled and distributed in the plastic solution 1, being processed by an Atmospheric Pressure Plasma (APP) technology, and having its surface provided with hydrophilic functional groups; and a second thermal conductive material 3, filled and distributed in the plastic solution 1, being processed by the Atmospheric Pressure Plasma (APP) technology or chemical modification, and having its surface provided with hydrophilic functional groups. In FIG. 1, the first thermal conductive material 2 is shown as a larger ellipse having its major (long) axis in the vertical direction, while the second thermal conductive material 3 is shown as a smaller ellipse having its major axis in the horizontal direction. For the plastic solution 1, Polydimethylsiloxane (PDMS) can be utilized. The first thermal conductive material 2 is mainly formed by ceramic powders of aluminum nitride (AlN), and it may further include larger powder grains and smaller powder grains of different grain radius, with the larger powder grain having grain radius 30 μm, and with the smaller powder grain having grain radius 10 μm. As such, through mixing and cooperation of powder grains of various different grain radiuses, the filling rate in the plastic solution 1 can be increased, to be beneficial to form thermal conduction path. In addition, the first thermal conductive material 2 may further utilize powder grains of a plurality of different grain radiuses, to mix with the second thermal conductive material 3. The second thermal conductive material 3 is mainly formed by carbon-containing ingredient, it can be single layer or multi layer graphene, or it can be carbon nano-tubes.

In the present embodiment, the grain radius of the first thermal conductive material 2 is greater than that of the second thermal conductive material 3, while most of the first thermal conductive material 2 and the second thermal conductive material 3 are in touch with each other. As such, both are formed by materials of high thermal conduction coefficient, while both are in touch with each other, to form thermal conduction path. Through mixing powder grains of different grain radiuses, the filling rate in the plastic solution 1 is increased. Therefore, in the plastic solution 1, through the Thermal Conduction Bridge Mechanism of the fully mixed first thermal conductive material 2 and the second thermal conductive material 3, a thermal conduction synergistic effect is produced, to realize the function of thermal interface material (TIM), so that the thermal conduction plastic material may have superior thermal conduction capability. Moreover, through using the Atmospheric Pressure Plasma (APP) technology, the powder grains of the first thermal conductive material 2 and the second thermal conductive material 3 are performed Surface Modification Treatment, to form Hydrophilic Functional Groups on both of their surfaces, to enhance the contact and distribution among the first thermal conductive material 2, the second thermal conductive material 3, and the plastic solution 1. Of course, in some specific embodiment, the plastic solution 1 can be mixed with only one of the first thermal conductive material 2 and the second thermal conductive material 3, and then after APP processing, the thermal conduction capability of the thermal conduction plastic material can also be increased.

TABLE 1

| | | thermal |
|---|---|---|
| | | conduction |
| | | coefficient |
| No. | ingredient of thermal conduction material | K(W/mK) |
| 1 | first thermal conduction material 2: 60 wt % | 2.3 |
| | AlN having APP. | |
| | second thermal conduction material 3: 2 wt % | |
| | graphene and multi wall carbon nano-tube, | |
| | having APP. | |
| 2 | first thermal conduction material 2: 60 wt % | 1.7 |
| | AlN having APP. | |
| | second thermal conduction material 3: 2 wt % | |
| | graphene and multi wall carbon nano-tube, no APP. | |
| 3 | first thermal conduction material 2: 70 wt % | 1.6 |
| | AlN having APP. | |
| | second thermal conduction material 3: not added. | |
| 4 | first thermal conduction material 2: 70 wt % | 1.0 |
| | AlN no APP | |
| | second thermal conduction material 3: not added | |

Refer to Table 1 above for the test data indicating the impact of APP on the thermal conduction coefficient of the thermal conduction plastic material. The sample utilized in the test is a test strip of a cured thermal conduction plastic material, having its length 2 cm, width 2 cm, and thickness 1 mm. In the first group and second group tests, the first thermal conductive material 2 is performed APP for both groups, while, the second thermal conduction material 3 is only performed APP for the first group. The test results indicate that, the thermal conduction coefficient for the thermal conduction plastic material of the first group thus obtained is 2.3K, that is considerably greater than that of the second group of 1.7K. As such, it is proved that APP does indeed raise the thermal conduction coefficient, and enhance the heat dissipation effect of the thermal conduction plastic material. Then, refer to the third group and the fourth group tests, in which both groups utilizes 70 wt % AlN as the first thermal conductive material 2 without adding the second thermal conduction material 3, while only the first thermal conductive material 2 of the third group is subject to APP treatment. The results of the test indicate that, the thermal conduction coefficient of the third group having APP treatment is 1.6K, that is far greater than that of the fourth group of 1.0 K. As such, it is proved that, even only one type of thermal conduction material is used, APP treatment does indeed raise the heat dissipation effect of the thermal conduction plastic material thus obtained.

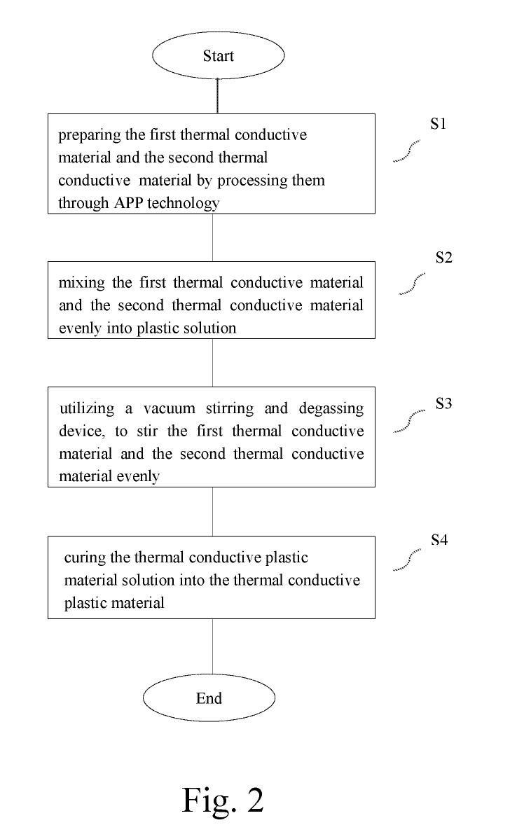

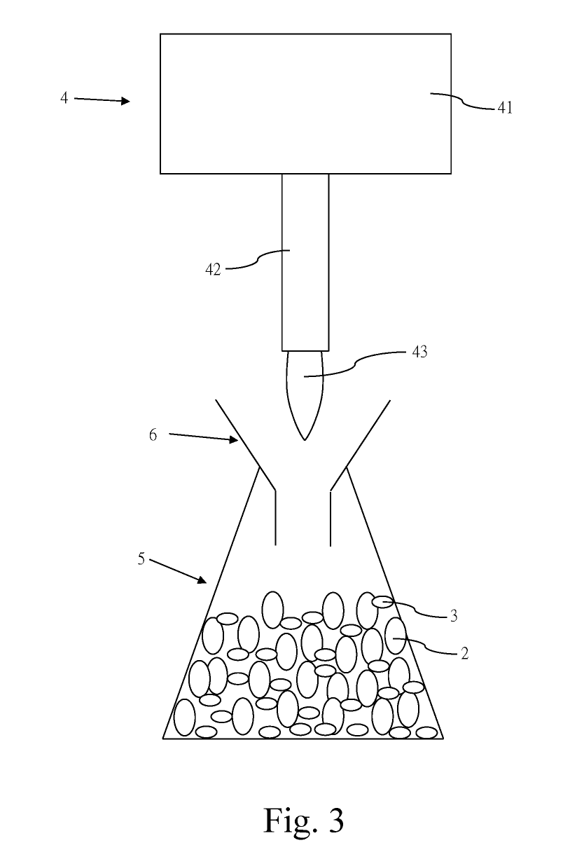

In the following, refer to FIGS. 2 and 3 respectively for a flowchart of the steps of a thermal conductive plastic material manufacturing method according to an embodiment of the present invention; and a schematic diagram of equipment used to perform surface modification treatment for the first thermal conductive material and the second thermal conductive material through using the Atmospheric Pressure Plasma (APP) technology according to an embodiment of the present invention.

As shown in FIG. 3, the equipment for manufacturing the thermal conductive plastic material includes: an Atmospheric Pressure Plasma (APP) device 4, a container 5, and a funnel 6. The APP device 4 includes a main body 41, and a tube 42.

Further, as shown in step S1 of FIG. 2, firstly, preparing the first thermal conductive material 2 and the second thermal conductive material 3, both being processed by the Atmospheric Pressure Plasma (APP) technology, thus having hydrophilic function groups on their surfaces. To be more specific, as shown in FIG. 3, the APP device 4 is utilized to perform surface modification treatment for the first thermal conductive material 2 and the second thermal conductive material 3 placed in the container 5 through utilizing Atmospheric Pressure Plasma (APP). The Atmospheric Pressure Plasma (APP) device 4 includes: a main body 41, used to generate the atmospheric pressure plasma; and a tube 42, for the plasma to pass through, and to output the APP beam 43. The APP beam 43 is generated from clean dry air (CDA), and is guided into the container 5 through a funnel 6, to ensure stable process operation, and to prevent the first thermal conductive material 2 and the second thermal conductive material 3 from escaping from the container 5. In general, the surface modification treatment is performed by the APP beam 43 for 1-10 minutes, to modify the surfaces of the first thermal conductive material 2 and the second thermal conductive material 3. In the present invention, clean dry air (CDA) is used to produce APP, but the present invention is not limited to this. Also, the equipment utilized to produce the thermal conductive plastic material mentioned above is by way of example only, but the present invention is not limited to this.

Subsequently, as shown in step S2, the first thermal conductive material 2 the second thermal conductive material 3 are mixed into the plastic solution 1. The weight percentage of the first thermal conductive material 2 is between 30 wt % to 80 wt %, the higher the weight percentage, the better the thermal conduction effect and viscosity. In case the weight percentage is kept at less 80 wt %, that could ensure good thermal conduction effect for the thermal conduction plastic material thus obtained, without it being too viscous to carry out the application process later. The first thermal conductive material 2 can be formed by mixing thermal conductive materials having different grain radius ratio of 1:4 to 1:10. The second thermal conductive material 3 can be formed by graphene or carbon nano-tube, or their combination.

Then, as shown in step S3, a vacuum stirring and degassing device such as a planetary mixer is used to perform mixing and stirring for the first thermal conductive material 2 and the second thermal conductive material 3 put into the plastic solution 1, through using the shearing force produced by the speed difference of rotation and revolution of the vacuum stirring and degassing device. Then, a pump is used to form a vacuum environment to perform vacuum stirring and degassing, so that the first thermal conductive material 2 and the second thermal conductive material 3 can be distributed more evenly in the plastic solution 1, while the gas bubbles in the plastic solution 1 can be discharged, to prevent the bubbles from becoming an unnecessary thermal medium. After the stirring process mentioned above, the remaining heat may still exist due to collisions and frictions between the powder grains. Therefore, the temperature caused by stirring can be lowered by reducing the speeds of rotation and revolution, and the ensuing shearing force in the later part of the stirring process. Of course, the step S3 can be performed by other stirring approaches, and is not limited to a vacuum environment or through a planetary mixer.

Finally, as shown in step S4, the thermal conductive plastic material solution produced in step S3 is applied onto a heat source to perform curing, to obtain the thermal conductive plastic material as required.

Summing up the above, in the present invention, in the plastic solution 1 a first thermal conductive material 2 and a second thermal conductive material 3 having high thermal conduction coefficient are added as Thermal Interface Material (TIM), so that heat can be dissipated through the thermal conduction path established through the first thermal conductive material 2 and the second thermal conductive material 3, in achieving superior heat dissipation effect. Further, Surface Modification Treatment is performed in advance for the first thermal conductive material 2 and the second thermal conductive material 3 through using an Atmospheric Pressure Plasma (APP) technology, to increase the distribution of the first thermal conductive material 2 and the second thermal conductive material 3 in the plastic solution 1, to further enhance the heat dissipation effect.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A thermal conductive plastic material, comprising:
a plastic solution;
a first thermal conductive material, filled and distributed in the plastic solution, being processed by an Atmospheric Pressure Plasma (APP) technology, and having its surface provided with hydrophilic functional groups; and
a second thermal conductive material, filled and distributed in the plastic solution, being processed by the Atmospheric Pressure Plasma (APP) technology or chemical modification, and having its surface provided with the hydrophilic functional groups;
wherein, the first thermal conductive material is formed by ceramic powders, the second thermal conductive material is formed by carbon-containing ingredient, while the first thermal conductive material and the second thermal conductive material are in touch with each other.

2. The thermal conductive plastic material as claimed in claim 1, wherein the first thermal conductive material includes big powder grains and small powder grains of different grain radiuses.

3. The thermal conductive plastic material as claimed in claim 2, wherein the big powder grains having a radius of 30 μm, while the small powder grains having a radius of 10 μm.

4. The thermal conductive plastic material as claimed in claim 1, wherein the first thermal conductive material is formed by powder grains having radius of 10 μm to 30 μm.

5. The thermal conductive plastic material as claimed in claim 1, wherein the second thermal conductive material is formed by graphene or carbon nano-tube.

6. The thermal conductive plastic material as claimed in claim 1, wherein the first thermal conductive material has a weight percentage of 30% to 80%.

7. The thermal conductive plastic material as claimed in claim 1, wherein the first thermal conductive material and the second thermal conductive material are of a grain powder shape, while radius of the former is larger than that of the latter.

8. A method of manufacturing the thermal conductive plastic material as claimed in claim 1, comprising the following steps:
step 1: preparing the first thermal conductive material and the second thermal conductive material, both being processed by the Atmospheric Pressure Plasma (APP) technology, thus having hydrophilic function groups on their surfaces;
step 2: mixing the first thermal conductive material and the second thermal conductive material evenly into the plastic solution, to obtain a thermal conductive plastic material solution;
step 3: utilizing a vacuum stirring and degassing device, to stir the first thermal conductive material and the second thermal conductive material, so that they are distributed evenly in the plastic solution, while discharging the bubbles from the plastic solution; and
step 4: curing the thermal conductive plastic material solution into the thermal conductive plastic material.
